(19) United States
(12) Patent Application Publication
(10) Pub. No.: US 2006/0273651 A1
(43) Pub. Date: Dec. 7, 2006

(54) Barnes & Barnes Neck Reliever

(76) Inventor: Ray A. Barnes, Bowdon, GA (US)

Correspondence Address: Ray A. Barnes, 3190 Victory Church Drive, Bowdon, GA, 30108, US

(21) Appl. No.: 11/280,512

(22) Filed: Nov. 17, 2005

Related U.S. Application Data
(63) Continuation-in-part of application No. 10/896,350, filed on Jul. 21, 2004, now abandoned.
Application No. 10/896,350 is a continuation-in-part of application No. 10/213,198, filed on Aug. 5, 2002, now abandoned.

(51) Int. Cl. B60R 22/00

(52) U.S. Cl. 297/482

(57) ABSTRACT

A unitary neck reliever for a seatbelt having two straps comprising a base with a front side and a back side, said base including an H-shaped slit having a left opening and a right opening, and a clip connected to said base defining a strap holding area therebetween, wherein the first strap is threaded into said left opening and along the back side of the base and threaded out through said right opening, and the second strap is clipped into said strap holding area.

### CROSS-REFERENCE TO RELATED APPLICATION

This is a continuation-in-part of co-pending Ser. No. 10/896,350, filed Jul. 21, 2004 which is a continuation-in-part of Ser. No. 10/213,198, filed Aug. 5, 2002.

### BACKGROUND OF THE INVENTION

The present invention relates to an apparatus that provides the user of a human retaining mechanism including a seat belt in combination with a shoulder strap with greater comfort than provided by the prior art.

### BRIEF SUMMARY OF THE INVENTION

The present invention (the Barnes & Barnes seat belt shoulder strap Neck Reliever) has been specifically designed for providing the user with dramatically increased comfort. As a result the Neck Reliever encourages greater use of a seat belt's shoulder straps since one of the major reasons for their non-use is the discomfort afforded by standard seat belt shoulder strap arrangements.

### BRIEF DESCRIPTION OF THE DRAWINGS

FIG. 1 is a perspective view of the apparatus of the present invention.

FIG. 2 is a side view of the apparatus of the present invention.

FIG. 3 is a top view of the present apparatus.

FIG. 4 is a bottom view of the present apparatus.

FIG. 5 is a front view of the present apparatus.

FIG. 6 is a rear view of the apparatus of the present invention.

FIG. 7 is a rear view of the present apparatus.

FIG. 8 is a frontal view of the present apparatus.

FIG. 9 is a rear view of the present apparatus showing a seat belt inserted into flap A.

FIG. 10 is a rear view of the present apparatus showing a seatbelt inserted into flap B.

FIG. 11 is a front view of the present apparatus showing a shoulder strap inserted behind flap C.

FIG. 12 is a front view of the present apparatus showing a shoulder strap inserted behind flap C and extending upwardly toward the neck of a user.

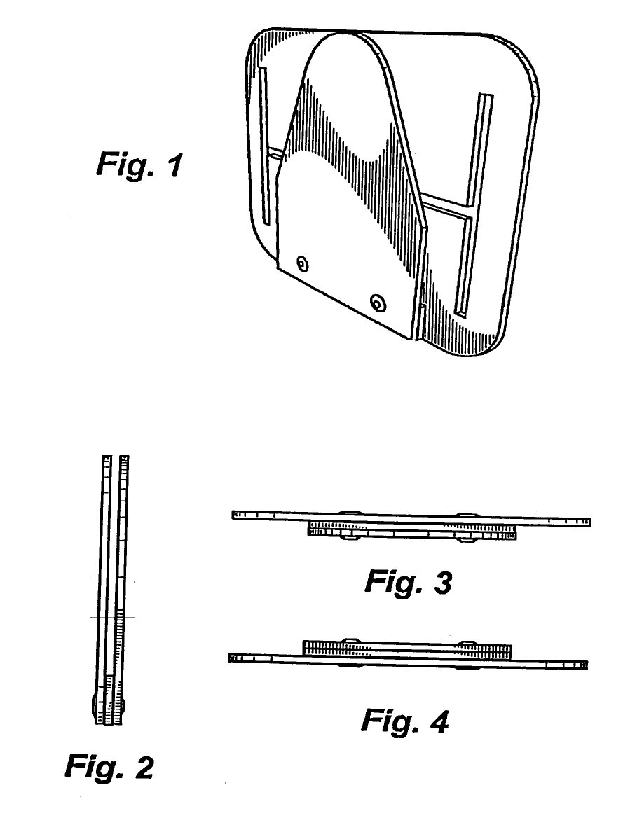

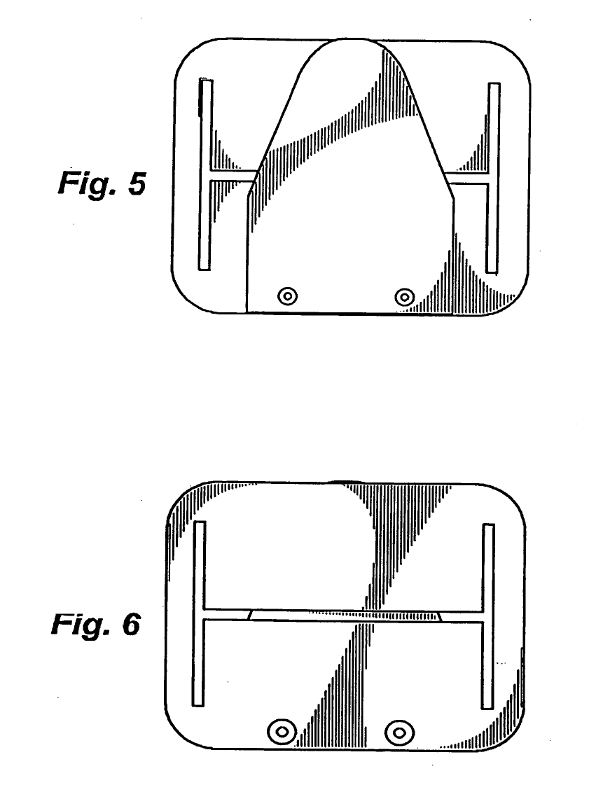

### DETAILED DESCRIPTION OF THE INVENTION

The flexibility of the Neck Reliever results in a lack of hazardous edges or corners that could cause injury or penetrate the body in an accident. It has been found that the use of the Neck Reliever prototype provides a decided advantage in safety in that it will, if adjusted according to the instructions, hold the shoulder strap flat, i.e. sideways, against the neck instead of the normal position. The normal position for the shoulder strap is lying flat on the shoulder thereby presenting a cutting edge similar to a sharp knife against the neck. The shoulder strap in its normal position under the pressure resulting from an automobile accident can, and has according to news reports, caused decapitation of users.

Although it would be difficult to adequately quantify the degree of comfort to one using the Neck Reliever, all users tested reported increased comfort compared to a standard seat belt shoulder strap arrangement.

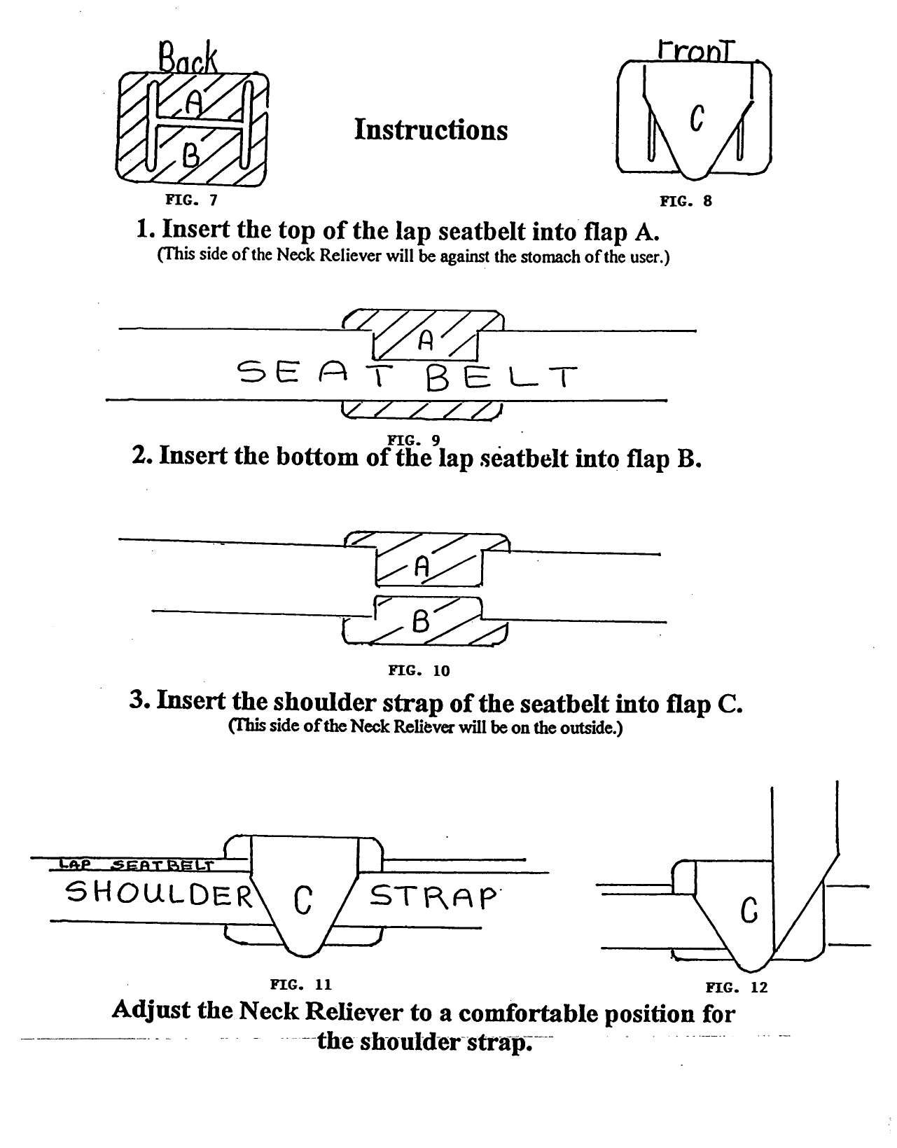

Instructions for using the present invention, referring to FIGS. 7-12:

1. Insert the top of the lap seatbelt into flap A. (This side of the Neck Reliever will be against the stomach of the user.)

2. Insert the bottom of the lap seatbelt into flap B.

3. Insert the shoulder strap of the seatbelt into flap C. (This side of the Neck Reliever will be on the outside.)

Adjust the Neck Reliever to a comfortable position for the shoulder strap.

The present invention is a unitary neck reliever for a seatbelt which includes a shoulder strap, comprising a base with a front side and a back side, said base including an H-shaped slit having a left opening and a right opening, and a clip spaced apart from and connected to said base substantially parallel to the base and defining a strap holding area therebetween, wherein said base and said clip are non-releasably attached. Advantageously the neck reliever further comprises a first strap threaded into said left opening and passing along the back side of the base and threaded out through said right opening, and a second strap clipped into said strap holding area. Preferably said first strap is a shoulder strap and said second strap is a lap strap. Alternatively said first strap is a lap strap and said second strap is a shoulder strap. Advantageously any slack present in the strap can be pulled from said shoulder strap and wrapped around said clip.

What is claimed is:

1. A neck reliever for a seatbelt having two straps, comprising:
a base with a front side and a back side, said base including an H-shaped slit having a left opening and a right opening, and
a clip spaced apart from and connected to said base substantially parallel to the base and defining a strap holding area therebetween, wherein said base and said clip are non-releasably attached.

2. The neck reliever of claim 1, further comprising:
a first strap threaded into said left opening and passing along the back side of the base and threaded out through said right opening, and
a second strap clipped into said strap holding area.

3. The neck reliever of claim 2, wherein said first strap is a shoulder strap and said second strap is a lap strap.

4. The neck reliever of claim 2, wherein said first strap is a lap strap and said second strap is a shoulder strap.

5. The neck reliever of claim 3, further comprising slack pulled from said shoulder strap and wrapped around said clip.

6. The neck reliever of claim 1 wherein the base and clip are a unitary structure.

7. The neck reliever of claim 6 wherein the base and clip are formed as a single structure.
